(19) United States
(12) Patent Application Publication
(10) Pub. No.: US 2025/0092918 A1
(43) Pub. Date: Mar. 20, 2025

(54) DRIVETRAIN AND CONSTANT VELOCITY JOINTS FOR RECREATIONAL VEHICLES

(71) Applicant: Polaris Industries Inc., Medina, MN (US)

(72) Inventors: Prasad Bhaskar Poojari, Nashik (IN); Daniel S. Weber, North Branch, MN (US); Marc Vanderhoof, Osceola, WI (US); Bryce R. Evans, Greenbush, MN (US); Jacob Grobbel, Milltown, WI (US); Adam Schlangen; Steve Nelson, Osceola, WI (US); Michael Whiting, North Branch, MN (US); Ron Danielson, Roseau, MN (US); Brenden Bungert, Chisago City, MN (US); Jeremy Lyons, Lindstrom, MN (US); Jacob Frank, Milltown, WI (US); Spencer Rosar, Wyoming, MN (US)

(21) Appl. No.: 18/830,810

(22) Filed: Sep. 11, 2024

Related U.S. Application Data
(60) Provisional application No. 63/582,989, filed on Sep. 15, 2023.

(51) Int. Cl. F16D 3/2237

(52) U.S. Cl. CPC F16D 3/2237

(57) ABSTRACT

Drivetrains and constant velocity joints for recreational vehicles are disclosed. These joints comprise a housing, an aperture for connecting with an axle, and interior components for rotatably connecting the axle to the housing. Various retention mechanisms improve the retention of constant velocity joints, including hydraulic-based, disc-based, pin-based, spline-based, and spring ring-based mechanisms. Hydraulic-based systems utilize adjustable hydraulic pressure for maintaining engagement. Disc-based mechanisms employ a conical disc that provides additional frictional force to resist pull-out forces. Pin-based retention involves drive pads or pins and corresponding tracks or grooves in the shaft interfacing gear. Spline-based mechanisms include a toolless locking half shaft retention system with rotating, interrupted splines. Spring ring-based retention features multiple flexible retaining rings placed axially along the spline, providing improved shaft retention. These retention mechanisms enhance the performance and reliability of recreational vehicle drivetrains by securing the constant velocity joint connections.

### CROSS REFERENCE TO RELATED APPLICATIONS

This application claims the benefit of U.S. Provisional Patent Application No. 63/582,989, filed Sep. 15, 2023, entitled DRIVETRAIN AND CONSTANT VELOCITY JOINTS FOR RECREATIONAL VEHICLES, the contents of which are expressly incorporated herein by reference.

### BACKGROUND

Recreational vehicles, such as all-terrain vehicles (ATVs) and utility vehicles (UTVs), are popular off-road vehicles designed to handle rough terrain and harsh environments. ATVs are typically smaller and more agile, while UTVs are larger and often equipped with a cargo bed for hauling materials and/or seats for additional passengers. Both types of vehicles are commonly used for recreational activities such as hunting, camping, and trail riding, as well as for work-related tasks like farming, construction, and search and rescue.

One of the key components of ATVs and UTVs is the drivetrain, which transfers power from the engine to the wheels. The drivetrain typically comprises a transmission, differential, and axles. The transmission regulates the engine's speed and torque to accommodate varying driving conditions. Meanwhile, the differential distributes power evenly between the wheels, allowing for smooth turning and enhanced traction. The axles serve as a connection between the wheels and the differential, facilitating wheel rotation.

Half shafts, also known as axle shafts, play a vital role in the drivetrain of ATVs and UTVs. These elongated metal shafts transmit power from the differential to the wheels, allowing them to rotate. Typically constructed from robust materials like steel or aluminum, half shafts are designed to withstand the rugged terrain these vehicles frequently traverse. Depending on the specific application and the anticipated stress levels, half shafts can be either solid or hollow.

Overall, ATVs and UTVs are versatile and durable vehicles designed to handle a wide range of tasks and environments. The drivetrain and its included components play a key role in ensuring the vehicle's reliability and performance in challenging conditions. As with any vehicle, regular maintenance and proper use are important to ensure that these components and the vehicle as a whole remain in good working order.

### SUMMARY

According to embodiments of the present disclosure, a drive train and associated components are disclosed. Specifically, various embodiments are directed to improvements in constant velocity joint retention mechanisms. Various embodiments provide improvements to traditional retention methods for constant velocity joints, which generally utilize a snap ring inserted into a groove on a splined locking element. When the locking element is inserted into a receiving hub, the snap ring is compressed as it passes through the hub splines. When the shaft is fully inserted, the hub has a machined feature that allows the snap ring to expand and lock the shaft in place. However, Applicants have determined that if the angle of the hub feature is too steep, removal of the shaft for service can become very difficult. Further, if the angle is not steep enough, there is risk that the shaft will fall out during use.

As such, various embodiments of the disclosure are directed to improvements in constant velocity joint retention mechanisms for maintaining a secure connection between the constant velocity joint and a drive hub, differential, gearbox, and the like. Such embodiments further provide for the easy insertion and removal of the shaft while providing positive and secure retention once the shaft is in place. As such various embodiments, by providing an enhanced locking feature, ensure that the half shaft is securely retained within the receiving hub, and enhances the reliability and performance of drive units in various applications. Furthermore, various embodiments simplify the process of inserting and removing the half shaft, streamlining maintenance procedures, and reducing the risk of damage during servicing. Further, various embodiments are designed as “plug and play” components, minimizing changes to the surrounding system such that embodiments are generally capable of horizontally deploying in another vehicle platform without comprising on the current/new driveline architecture and with minimal cost impact.

As such, various embodiments relate to a constant velocity joint designed for use in recreational vehicles. The joint comprises a housing made from a rigid material that extends from a rearward end to a forward end. The rearward end has an aperture for receiving and rotatably connecting with an axle, which leads to an interior space surrounded by the housing's cylindrical body. Additionally, the joint includes one or more interior components for rotatably connecting the axle to the housing. The constant velocity joint includes a forward locking element, which is positioned on the forward end of the housing. This element includes several splines that run parallel to the housing's central axis and are distributed around the forward locking element. The forward locking element also includes a circumferential groove with a snap ring inserted into it.

Furthermore, various embodiments describe retention mechanisms for securing the housing in place during installation into a receiver. In one or more embodiments the retention mechanism comprises a hydraulic channel containing hydraulic fluid, a set screw, and a movable set pin. The hydraulic channel has two ends, with the first end defining an opening into the channel and the second end positioned next to the forward locking element's groove. The movable set pin, located in the second end of the channel, is vertically adjustable via fluid pressure. This pin can determine the depth of the groove according to its position in the second end. The set screw, positioned in the first end of the channel, can be adjusted upwardly or downwardly to increase or decrease the pressure from the hydraulic fluid in the channel.

In one or more embodiments the retention mechanism comprises a conical disc having a diameter that approximately matches the diameter of a forward face of the forward locking element, the conical disc defining a concave surface and a convex surface. When inserted into a receiver, side edges of the conical disc can engage the interior surface of the receiver when the housing is pulled rearwardly such that the conical disc provides additional frictional force to resist rearward pull-out force.

In one or more embodiments the retention mechanism comprises a spline lock that is rotationally mounted to a forward face of the locking element via a rotating shaft. In one or more embodiments the spline lock is a toolless locking half shaft retention system defining a separate a rotating set of splines positioned adjacent to splines of the forward locking element. In various embodiments a rotational spring is mounted to the shaft and configured to rotate the mechanism from a first position where the splined section and the splines are aligned, to a second position where the splined section and the splines are misaligned, preventing a sliding interaction between a splined receiver and splined constant velocity joint. In one or more embodiments the retention mechanism comprises one or more pins positioned on the forward locking element and corresponding with one or more tracks in a receiver. In various embodiments one or more tracks in the receiver comprise a first axial portion extending axially for providing a track for the pins to enter the receiver, a first circumferential portion providing a track for the pins to rotate and offset from the first axial portion, and a second axial portion providing a track for the pins to move axially rearwardly into a groove, thereby providing a secure connection between the receiver and the housing;

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a perspective view of a recreational vehicle, according to one or more embodiments of the disclosure.

FIG. 2 depicts a bottom view of a recreational vehicle and a drivetrain, according to one or more embodiments of the disclosure.

FIG. 3A depicts a partial rear perspective view of a rear portion of a recreational vehicle and a drivetrain, according to one or more embodiments of the disclosure.

FIG. 3B depicts a cross-sectional side view of a constant velocity joint, according to one or more embodiments of the disclosure.

FIGS. 4A-4D depict cross-sectional side views of a constant velocity joint housing and a hydraulic retention mechanism, according to one or more embodiments of the disclosure.

FIGS. 5A-5C depict cross-sectional side views of a constant velocity joint housing and a retention mechanism, according to one or more embodiments of the disclosure.

FIG. 6 depicts a cross-sectional side view of a constant velocity joint and axial spring, according to one or more embodiments of the disclosure.

FIGS. 7A-7E depict perspective views, cross-sectional views, and front views of a constant velocity joint and retention mechanism, according to one or more embodiments of the disclosure.

FIG. 8A depicts a perspective view of a constant velocity joint boot camp, according to one or more embodiments of the disclosure.

FIG. 8B depicts a side view of a constant velocity joint boot, according to one or more embodiments of the disclosure.

FIG. 9 depicts a side view of a constant velocity joint boot, according to one or more embodiments of the disclosure.

FIGS. 10A-10B depicts cross-sectional side views of a constant velocity joint housing and a retention mechanism, according to one or more embodiments of the disclosure.

FIG. 11 depicts a cross-sectional side view of a constant velocity joint housing and a retention mechanism, according to one or more embodiments of the disclosure.

FIG. 12 depicts a rear view of a differential configured with a pair of cross-over half shafts, according to one or more embodiments of the disclosure.

FIG. 13 depicts a perspective view of a coupling device for connecting rotating shafts in vehicle drive trains, according to one or more embodiments of the disclosure.

FIG. 14 depicts an exploded view of a coupling device for connecting rotating shafts in vehicle drive trains, according to one or more embodiments of the disclosure.

FIG. 15 depicts a cross-sectional view of a coupling device for connecting rotating shafts in vehicle drive trains, according to one or more embodiments of the disclosure.

FIG. 16 depicts a partial cross-sectional view of the coupling device, according to one or more embodiments of the disclosure.

FIG. 17 depicts a steering system architecture with constant velocity joint steering shaft, according to one or more embodiments of the disclosure.

FIGS. 18-20 are various views of a double-piloted spline interface 1800, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

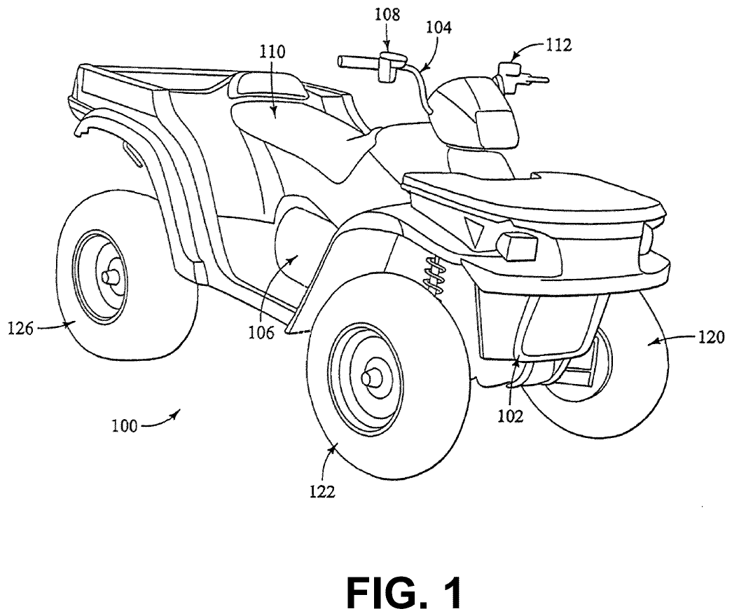

Referring to FIG. 1 a perspective view of a recreational vehicle 100 is depicted. In one or more embodiments the vehicle 100 is generally designed as an all-terrain vehicle (ATV) and comprises a frame 102 supporting a straddle-type seat 110, which is narrow enough for the rider to straddle comfortably. However, in various embodiments the vehicle could be any type of alternative recreational vehicle. For example, the vehicle 100 could be a utility vehicle (UTV) and/or may feature any of a variety of seating designs. For example, in one or more embodiments the vehicle 100 may feature a bucket-type seat and/or an additional passenger seat beside or behind the operator seat. In one or more embodiments vehicle 100 is equipped with a set of wheels including left front wheel 120, right front wheel 122, left rear wheel 124, and a right rear wheel (not visible in FIG. 1). A handlebar 104 is used to steer the vehicle.

In one or more embodiments, the left and right front wheels 120, 122 are connected to the frame 102 via a front suspension, while the left rear wheel 124 and right rear wheel are connected through a rear suspension. An engine 106, mounted on the frame 102, propels the vehicle by providing power to the rear and/or the front wheels through a drivetrain, described further below. Certain embodiments include an input device, such as a multi-position mode switch 108, mounted on the handlebar 104 for selecting different drive modes. The switch may offer three positions corresponding to on-demand four-wheel drive, two-wheel drive with a locked differential, and two-wheel drive with an open or unlocked differential. An optional second switch 112 can be added to the handlebar 104.

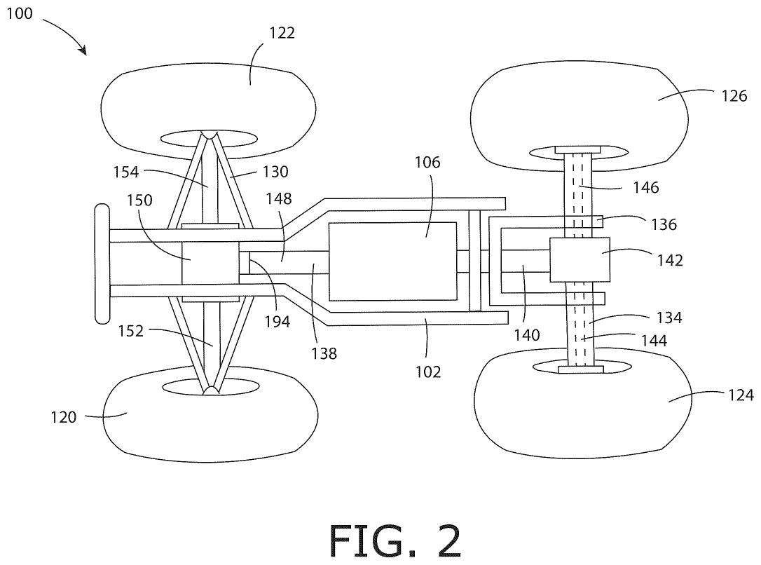

Referring to FIG. 2 illustrates a bottom view of a recreational vehicle 100, according to one or more embodiments. Depicted in FIG. 2, the vehicle 100 includes a frame 102 and a plurality of wheels 120, 122, 124, 126. In certain embodiments the front wheels 120, 122 are connected to the frame 102 via a front suspension 130. Additionally, rear wheels 124, 126 are connected to a rear axle assembly 134, which is in turn connected to the frame 102 by a trailing arm 136 that can rotate relative to the frame 102. The vehicle's engine 106, supported by the frame 102, selectively provides power to different wheels via a drivetrain 138.

In one or more embodiments, the drivetrain 138 includes a rear prop shaft 140 that delivers torque to a rear differential 142 that in turn drive a left rear half axle 144 and a right rear half axle 146. Rear differential 142 may be a lockable differential. In various embodiments drivetrain 138 includes a font prop shaft 148 that delivers torque to a front gearbox 150 that powers a left front half axle 152 and a right front half axle 154. Left front half axle 152 and right front half axle 154 are coupled to left front wheel 120 and a right front wheel 122, respectively. Left rear half axle 144 and right rear half axle 146 are coupled to left rear wheel 124 and a right rear wheel 126, respectively. In one or more embodiments, and described further below, the half axles 144, 146, 152, 154, are each coupled via one or more dual offset joints to allow for the transfer of torque from the engine to the wheels while allowing for a range of movement in the suspension. In one or more embodiments, the front gearbox 150 and/or rear differential 142 can be configured with front and/or rear wheels for additional gear reduction. For example, in certain embodiments the wheel hubs can be configured to perform some or all of the gear reduction from the gearboxes and/or differential. In such embodiments Having gear reduction at the wheel would increase ground clearance and reduce scrub through suspension travel. In various embodiments the half shafts could also be reduced in size because some of the torque reduction occurs at the wheel. This system also allows for a simple route for air for adjustable tire pressure. For example, in some embodiments, due to the reduced size of the half axle, an airline could be run through the axle. In certain embodiments, by providing gear reduction at the hubs rather than only at the gearboxes/differential, various embodiments allow for more suspension ride in, increased ground clearance and reduced torque in the half shafts.

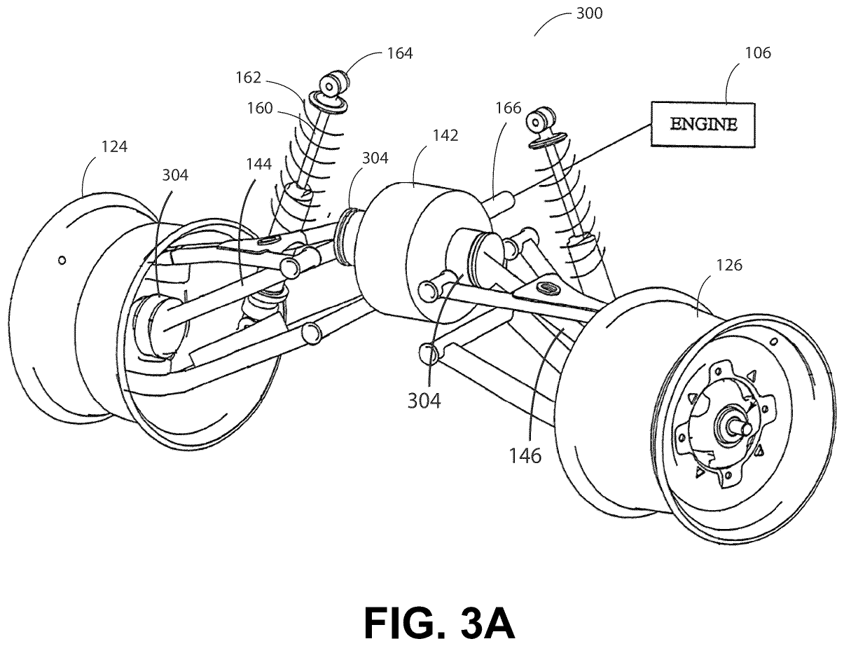

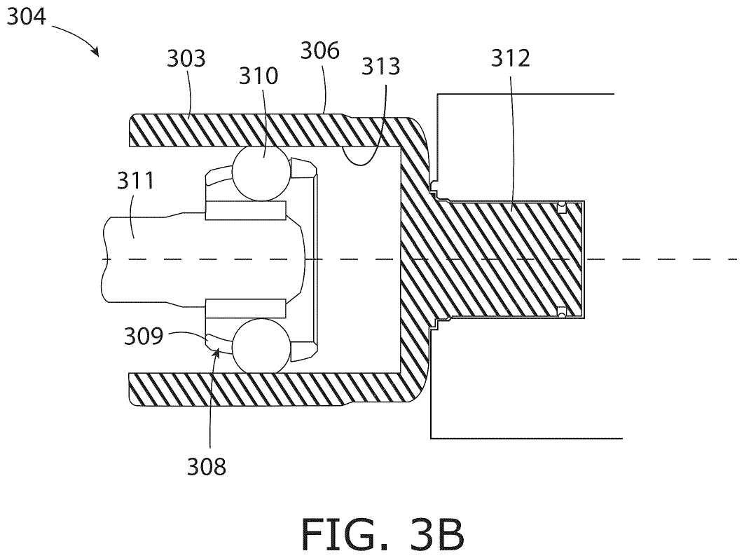

Referring additionally to FIG. 3A, a partial rear perspective view of the drivetrain 138 is depicted. In one or more embodiments, and as described above, the recreational vehicle 100 comprises an axle assembly 300 and a frame that forms a part of the vehicle 100. In one or more embodiments, the rear axle assembly 300 includes a rear differential 142, a left wheel 124 and right wheel 126. In various embodiments, the left wheel 124 is connected to a left rear half axle 144 and the right wheel is fixed to a right rear half axle 146. In one or more embodiments the rear axle assembly 300 includes the rear differential 142 having an input shaft 166. Rear differential 142 is preferably capable of selectively transferring rotational motion from input shaft 166 to the left wheel 124 and the right wheel 126 of rear axle assembly 300 via the left and right half axles 144, 146. As such, in various embodiments the half axles 144, 146 are each coupled to the differential 142 and the left and right wheels 124, 126 via one or more dual offset joints 304. In one or more embodiments the dual offset joints 304 function to couple the half axles 144, 146 between the differential 142 and the wheels 124, 126 to allow for the transfer of torque from the engine to the wheels while allowing for a range of movement in the suspension. In one or more embodiments, rear axle assembly 300 is coupled to frame by a suspension assembly. In one or more embodiments, the suspension assembly includes a first spring assembly 160 and a second spring assembly 160. Each spring assembly 160 includes a spring 162 that is disposed about a shock absorber 164. An engine 106 is illustrated using a box in FIG. 3A. In the embodiment of FIG. 3A, engine 106 is coupled to an input shaft 166 of a rear differential 142. Engine 106 and rear differential 142 may cooperate to selectively rotate the left rear half axle 144 and the right rear half axle 146. Left rear half axle 144 and right rear half axle 146 are coupled to left rear wheel 124 and a right rear wheel 126, respectively, as described above.

In one or more embodiments, the half axles 144, 146 can be configured with a torque limiting design, wherein the half axels 144, 146 incorporate a shear bolt, shear pin configured to fail at a specified torque that is below a torque failure threshold of one or more surrounding components. In such embodiments the torque limiting device can be integrated within a half shaft, designed to protect CV, DOJ, and the shaft from breakage due to over torque. In one or more embodiments the torque limiting device could range from a simple shear bolt or pin to a clutch mechanism. Currently, half shaft failures are costly and time-consuming, requiring the vehicle to be transported to a repair facility. This torque limiting device, however, allows for quick, convenient field repairs, turning a potentially ruined day of riding into a manageable inconvenience. The solution should be compact and easily replaced using the tools provided in the vehicle's toolkit.

In one or more embodiments one or more of the engine 106, differential 142, and gearbox 150 can be configured to include a bi-directional clutch assembly comprising a constant velocity (CV) joint inner element and torque transferring elements. In such embodiments the CV joint (DOJ) inner element or cage and torque transfer elements that, such as bearings, replace the standard cage and rollers used in current designs. In such embodiments the cage and torque transfer elements are housed internally within the drive housing or transmission, which leads to a reduction in the distance between pivots and results in increased suspension travel capability. Further, in various embodiments the bi-directional clutch includes a ramp profile built into the housing, which allows it to apply load while simultaneously enabling full-time engagement in both forward and reverse axial directions. In such embodiments, this increases the efficiency and performance of the drive mechanism. By using a specially designed ramp profile, the engine's torque is transferred to the wheels as the transmission shafts turn, engaging the balls to the ramp. This combination ultimately leads to a more efficient, higher-performing, and cost-effective solution with fewer parts required. Further, in contrast to existing designs that rely on rollers, a straight clutch profile, and a larger number of parts at higher costs, the integrated bi-directional clutch leverages the CV cage and bearings to create a more cost-effective and streamlined system.

Referring to FIG. 3B, a cross sectional view of a constant velocity joint 304 is depicted, according to one or more embodiments. In one or more embodiments, the constant velocity joint is configured as an rzeppa joint, including an outer element 306, comprising a housing 303, an inner element 308, comprising a connector joint 309 configured for connection with an end of a half axle 311, and a plurality of torque transferring elements 310. As shown, the constant velocity joint 304 is a double offset plunging constant velocity joint, including a joint pivot point that is defined by a midpoint of two separate points of articulation and the constant velocity joint 304 accommodates axial translation. In one or more embodiments the outer element 306 is a generally hollow cylindrical portion including a forward locking element 312 formed from a rigid material such as a steel. Described further below, the forward locking element 312 includes one or more features configured for connecting with and retaining a connection between the housing 303 and a receiver 312, such as a drive hub, differential, wheel hub, and the like, for transferring rotational force between the receiver and the housing 306 and axle 311.

In one or more embodiments the outer element 306 includes a plurality of tracks formed in an inner surface 313. In various embodiments, each of the outer tracks has an arcuate profile. Alternately, the outer element 306 may include the plurality of tracks having alternating depths. In certain embodiments the outer element 306 includes eight tracks formed therein. However, it is understood that each of the tracks may have a non-arcuate profile and any number of the tracks may be formed in the outer element 306. In various embodiments the plurality of tracks are equally spaced about the interior surface 313.

In one or more embodiments the inner element 308 is a hollow member formed from a rigid material such as a steel. The inner element 308 is typically formed separate from the half axle 311 and is spliningly disposed on an end portion of the half axle 311. However, it is understood the inner element 308 may be unitarily formed with the half axle 311. In one or more embodiments the inner element 308 defines a cylindrical bore through the inner element 308. A plurality of splines is formed on the inner element for drivingly engaging with the half axle 311. In certain embodiments the inner element 308 is secured to the half axle 311 using a snap ring disposed in a groove formed in an outer surface of the half axle 311. Alternately, any other type of fastener may be used to secure the inner element 308 to the half axle 311. For example, described further below various retention mechanisms are described for the forward locking element 312 and receiver. In various embodiments such embodiments could be adapted to secure the half axle 311 with the inner element 308.

In one or more embodiments a plurality of tracks are formed in the inner element outer surface. In various embodiments each of the inner tracks has an arcuate profile. Alternately, the inner element 308 may include the plurality of inner tracks having alternating depths. In various embodiments the number and/or size/diameter of each of the inner tracks is complementary to the profile of each of the outer tracks of the outer element 306 corresponding thereto. In one or more embodiments the plurality of torque transferring elements 310 comprises steel spheres, such as bearings, that are disposed in each of the outer tracks and the inner tracks. The torque transferring elements 310, inner element 308, and outer element 306 are precision machined for use as mating surfaces of a constant velocity joint as is known in the art. In one or more embodiments, in use, the constant velocity joint 304 facilitates articulation between the half axle 311 and the connected differential, drive hub, wheel hub, and the like. Additional discussion of constant velocity joints can be found in U.S. Pat. No. 8,641,538, which is incorporated by reference herein.

In one or more embodiments, the constant velocity joint 304 is configured as a unified plunging joint, where the joint 304 utilizes high angle rzeppa joints for inboard joints and incorporates a spline feature on the outer diameter for plunging within a drive housing. The drive housing has a splined profile through its center, while the inner joints employ rzeppa style non-plunging CV joints capable of 45 degrees of articulation. The outer surface of the outer race of the CV joint has a splined profile that slides within the splined portion of the final drive housing to achieve the necessary shaft plunge for suspension travel. Such embodiments present a new driveshaft design that enables the inner and outer elements to be closer together and allows for higher joint articulation compared to current CV/DOJ half shafts.

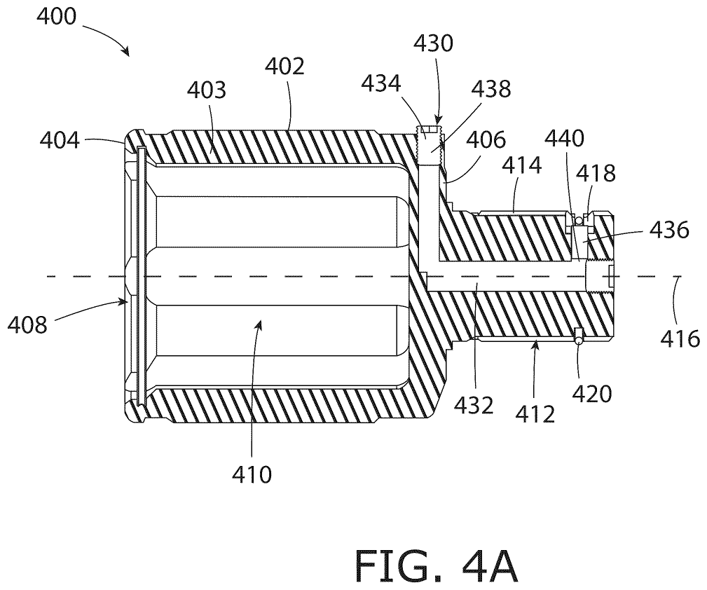

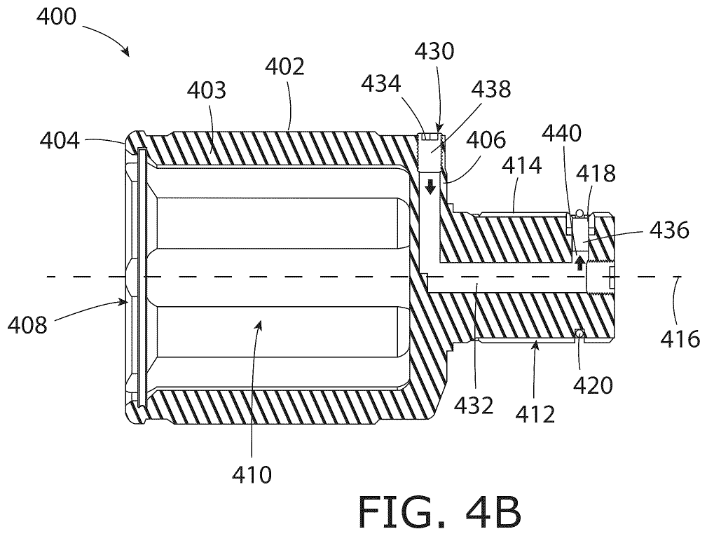

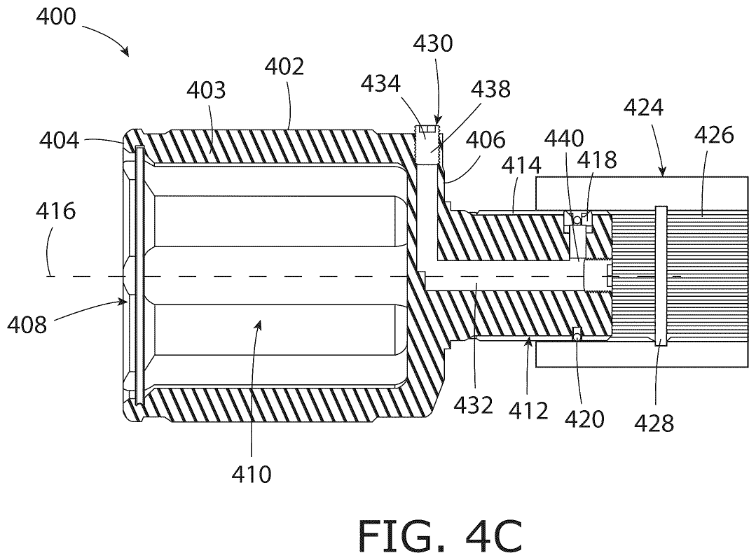

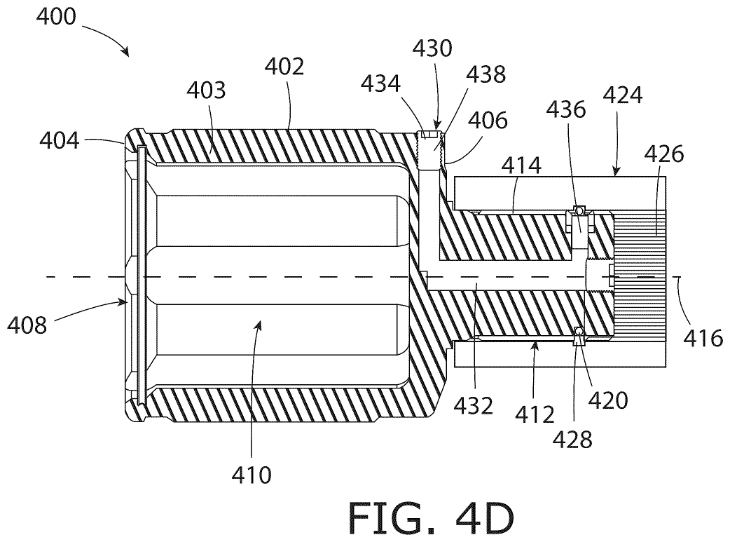

Referring to FIGS. 4A-4D, cross-sectional side views of a housing 402 for a constant velocity joint 400 is depicted, according to one or more embodiments. In one or more embodiments, the housing 402 is a cylindrical body 403 formed from a rigid material such as a steel. However, it is understood the housing 402 may be formed using any other process from any other material. In various embodiments the housing 402 extends from a rearward end 404 to a forward end 406. In one or more embodiments the housing 402 defines an aperture 408 in the rearward end 404 into an interior space 410 that is surrounded by the cylindrical body 403 for receiving and rotatably connecting with an axle. For simplicity, the interior components for rotatably connecting to an axle, along with the connected axle, have been omitted from FIGS. 4A-4D. In one or more embodiments a forward locking element 412 is positioned on the forward end 406 of the housing 402. The forward locking element is configured as a locking mechanism 413 for installation into a receiving hub of a wheel hub and/or drive unit, such as a front drive, rear drive, differential, or transmission.

In one or more embodiments, the forward locking element includes a plurality of splines 414 that extend parallel with a central axis 416 of the housing 402 and are distributed circumferentially about the forward locking element 412. In various embodiments, the forward locking element 412 further includes a circumferential groove 418 and a snap ring 420 that is inserted into the groove 418. Depicted in FIG. 4C, the drive unit and/or wheel hub includes a corresponding receiver 424 for the locking element 412. In such embodiments the receiver 424 includes a plurality of corresponding splines 426 and a groove 428 for receiving the snap ring 420. In such embodiments, upon insertion of the forward locking element 412, splines 414, 426 interlock to resist rotational force between the receiver 424 and housing 402 while the snap ring 420 and groove 428 function to resist rearward movement of the locking element 412 that would separate the connected housing 402 and receiver 424. Depicted in FIGS. 4A-4D, the housing and forward locking element 412 are shown as formed from one piece of material. However, in certain embodiments, the various components of the constant velocity joint 400 could be formed from multiple pieces and coupled together to form the constant velocity joint 400.

In one or more embodiments the housing 402 further includes a hydraulic locking mechanism 430 for locking the housing 402 in place upon installation into the receiver 426. In such embodiments, the hydraulic locking mechanism 430 facilitates the easy insertion and removal of the constant velocity joint 400, and/or while providing positive and secure retention once the shaft is in place. In one or more embodiments the hydraulic locking mechanism 430 includes a hydraulic channel 432 with hydraulic fluid, a set screw 434, and a movable set pin 436. In one or more embodiments, the hydraulic channel 432 is a machined fluid channel having at least two ends including a first end 438 and a second end 440. In one or more embodiments the first end 438 of the channel 432 is a radially extending portion, relative to the central axis 416, defining a first opening into the hydraulic channel 432 while the second end 440 of the channel 432 is positioned adjacent to the groove 418 of the forward locking element 412. In such embodiments the movable set pin 436 is positioned in the second end 440 of the channel 432 and is vertically adjustable in the channel 432 such that the set pin 436 determines the depth of the groove 418 via its relative position in the second end 440 of the channel 432. Similarly, in various embodiments the set screw 434 is positioned in the first end 438 of the channel 432.

In various embodiments the set screw 434 is vertically adjustable upwardly or downwardly in the channel 432 to increase or decrease the pressure from hydraulic fluid in the channel. The pressure in the channel in turn controls the position of the movable set pin 436. For example, as the pressure in the channel 432 increases the set pin 436 is pushed radially outward and in turn expands the snap ring 420 outwardly from the groove 418. For example, upon installation of the housing 402 into the receiver 424, the set screw 434 is advanced, causing an increase in hydraulic pressure within the channel 432. The increased pressure forces the movable set pin 436 to extend into a corresponding feature in the receiving hub, effectively retaining the constant velocity joint 400 from inside the receiver 424 and ensure a secure connection. In one or more embodiments, to remove the constant velocity joint 400 from the receiver 424, the set screw is retracted. This in turn reduces the hydraulic pressure in the channel 432. Consequently, the set pin 436 withdraws from the receiving hub feature or releases the snap ring 420, allowing for the easy removal of the constant velocity joint 400.

While FIGS. 4A-4D depict an arrangement with a channel 432 having two ends 438, 440, in certain embodiments the channel could have additional ends and additional set pins arranged in the forward locking element 412. In certain embodiments the snap ring 420 could be replaced with an alternative embodiment of the set pin 436. For example, in certain embodiments the set pin 436 could include one or more protruding features that, when extended radially out from groove 418 function to lock with groove 428 of the receiver 424.

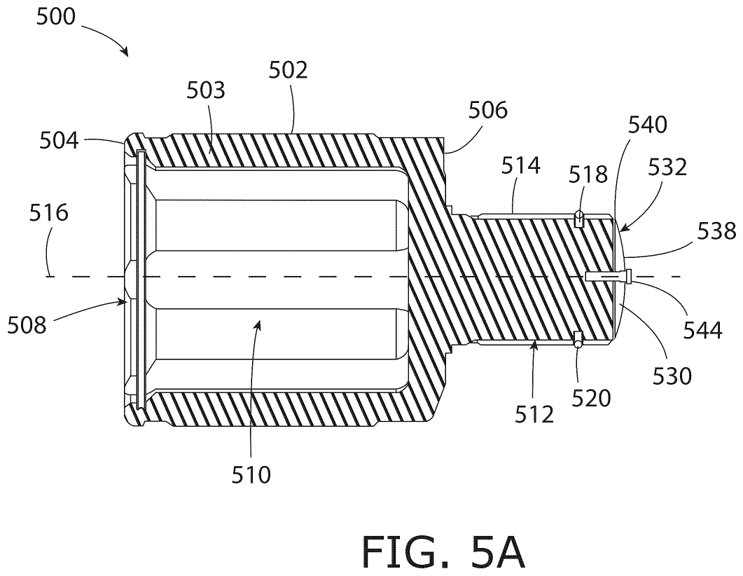

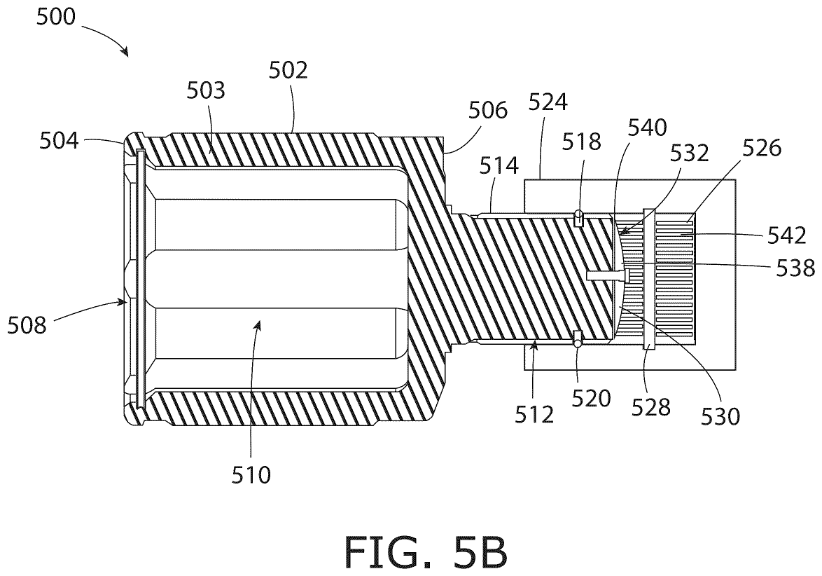

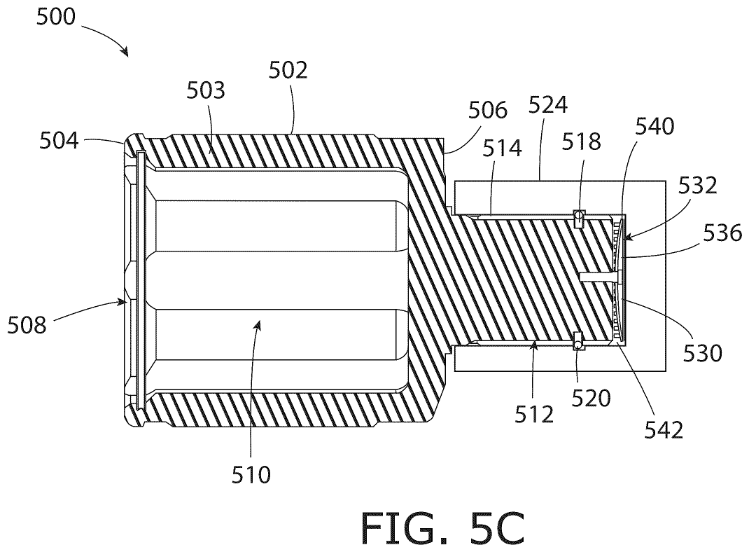

Referring to FIGS. 5A-5C, cross-sectional side views of a housing 502 for a constant velocity joint 500 is depicted, according to one or more embodiments. In one or more embodiments, the housing 502 is similar to housing 402 depicted above in FIGS. 4A-4D. For example, in various embodiments housing 502 extends from a rearward end 504 to a forward end 506. In one or more embodiments the housing 502 defines an aperture 508 in the rearward end 504 into an interior space 510 that is surrounded by the exterior cylindrical body 503 for receiving and rotatably connecting with an axle. A forward locking element 512 is positioned on the forward end 506 of the housing 502. The forward locking element is configured as a locking mechanism for installation into a receiving hub of a wheel hub and/or drive unit, such as a front drive, rear drive, differential, or transmission. In one or more embodiments, the forward locking element includes a plurality of splines 514 that extend parallel with a central axis 516 of the housing 502 and are distributed circumferentially about the forward locking element 512. In various embodiments, the forward locking element 512 further includes a circumferential groove 518 and a snap ring 520 that is inserted into the groove 518. Depicted in FIGS. 5B-5C, a drive unit and/or wheel hub includes a corresponding receiver 524 for the locking element 512. In such embodiments the receiver 524 includes a plurality of corresponding splines 526 and a groove 528 for receiving the snap ring 520. In such embodiments, upon insertion of the locking mechanism 512, splines 514, 526 interlock to resist rotational force between the receiver 524 and housing 502 while the snap ring 520 and groove function to resist rearward movement of the locking mechanism that would separate the connected housing 502 and receiver 524.

In one or more embodiments the housing 502 further includes a disc retention mechanism 530. In one or more embodiments the disc retention mechanism 530 comprises a conical disc 532 having a diameter that approximately matches the diameter of the forward face 534 of the forward locking element 512. In one or more embodiments the conical disc defines a concave surface 536 and a convex surface 538. In one or more embodiments, the disc 532 is configurable between at least two configurations, including one shown in FIGS. 5A-5B where the concave surface 536 is rearwardly facing and the convex surface 538 is forward facing. In certain embodiments, and as depicted in FIG. 5B, this configuration is generally used for insertion of the forward locking element 512 and disc retention mechanism 530 into the receiver 524. For instance, in such embodiments the forward convex surface allows for easy insertion into the receiver 424 with minimal friction between the conical disc and the sides of the receiver 424.

In certain embodiments, including one shown in FIG. 5C, the concave surface 536 is forward facing, and the convex surface 538 is rearward facing. The disc retention mechanism, in this configuration, provides additional retention force in the axial direction to overcome the pull-out forces. For example, in various embodiments the side edges 540 of the conical disc engage the interior surface 542 of the receiver when the housing is pulled rearwardly such that the conical disc 532 provides additional frictional force to resist rearward pull-out force. For example, Applicants have determined that the disc retention mechanism 530 provides an additional pull-out resistance of approximately 956 N. In certain embodiments this pull-out resistance, in combination with the snap ring 520 provides a pull-out resistance of approximately 1721N. In various embodiments the conical disc 532 is attached to the forward face 534 of the forward locking element via a bolt, screw, or other fastener 544.

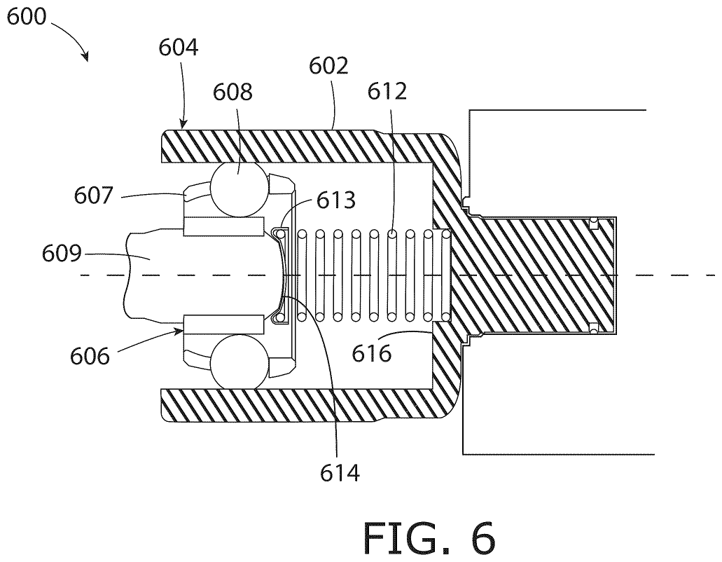

Referring to FIG. 6, a cross sectional view of a constant velocity joint 600 is depicted, according to one or more embodiments. In one or more embodiments, the constant velocity joint 600 includes an outer element 604, comprising a housing 602, an inner element 606, comprising a connector joint 607 configured for connection with an end of a half axle 609, and a plurality of torque transferring elements 608. As shown, the constant velocity joint 600 is a double offset plunging constant velocity joint. In various embodiments the constant velocity joint 600 is similar to constant velocity joint 304 depicted and described above with reference to at least FIGS. 3A-3B.

In one or more embodiments the constant velocity joint 600 further includes an axial spring 612. In various embodiments the axial spring 612 extends axially between a forward-facing end surface 614 of the half axle 609 and a rearward interior surface 616 of the housing 602. In one or more embodiments the axial spring 612 includes a cup 613 connected to one or more ends of the spring. In such embodiments the cup 613 is shaped to conform with one or more of the half axle 609 and the rearward interior surface 616. As such, in various embodiments the cup 613 improves connection between the elements and reduces the chance of misalignment or separation. In one or more embodiments the axial spring 612 functions to maintain an axial spacing between the outer element 604 and the inner element 606. For example, in certain instances the housing 602 is subjected to various pull-out forces, described above, which would close the distance between the inner and outer elements of the constant velocity joint 600 and, in some instances result in the housing 602 falling out of the receiver. However, the axial spring 612 functions to resist pull-out forces on the constant velocity joint 600 by assisting the housing 602 to maintain its forward position inside the receiver. Further, because the axial spring 612 is contained within the constant velocity joint 600, various embodiments require no modification to the receiver, allowing it to be deployed in any vehicle platform without comprising on the driveline architecture.

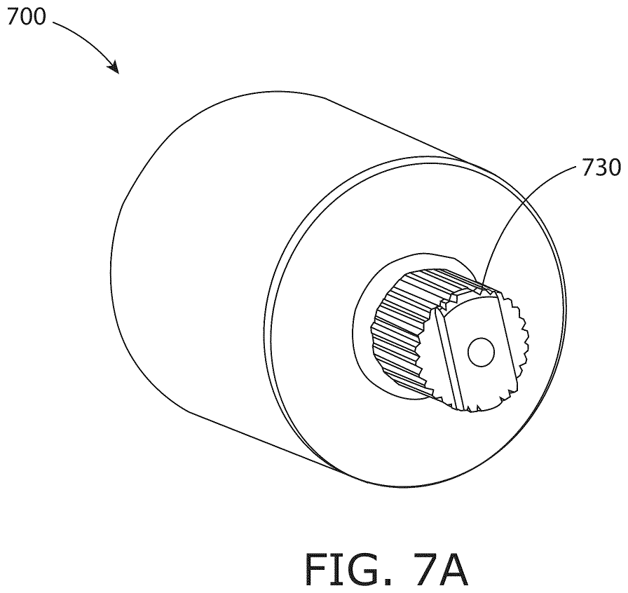

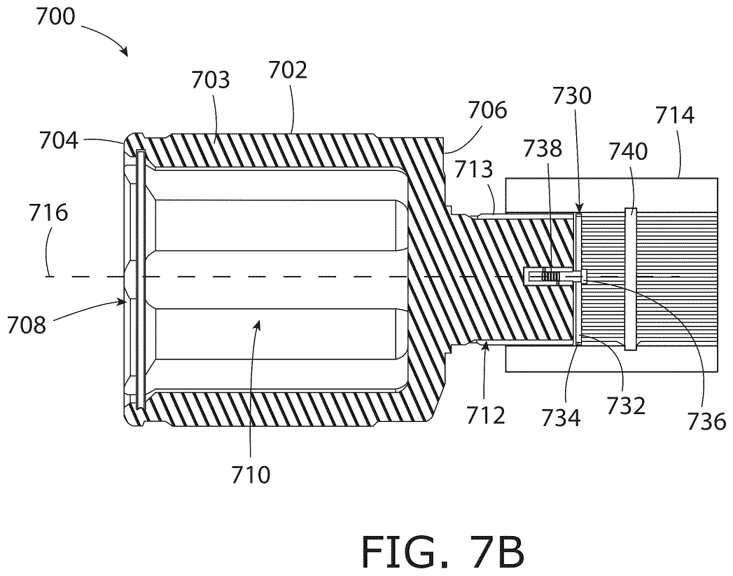

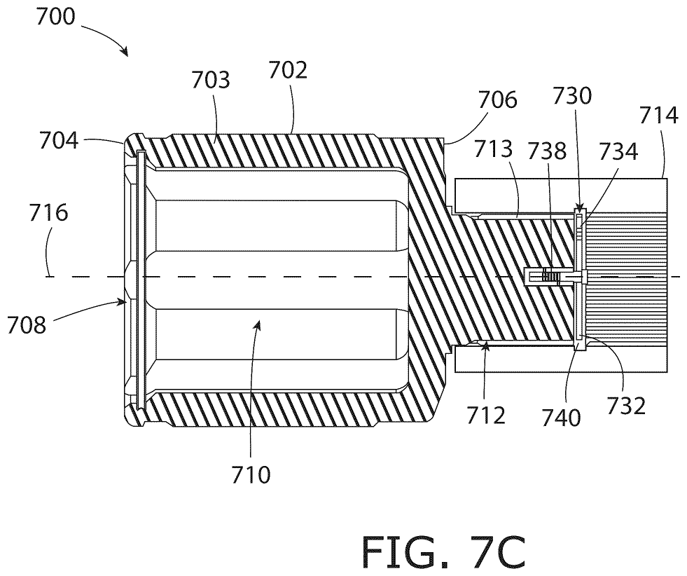

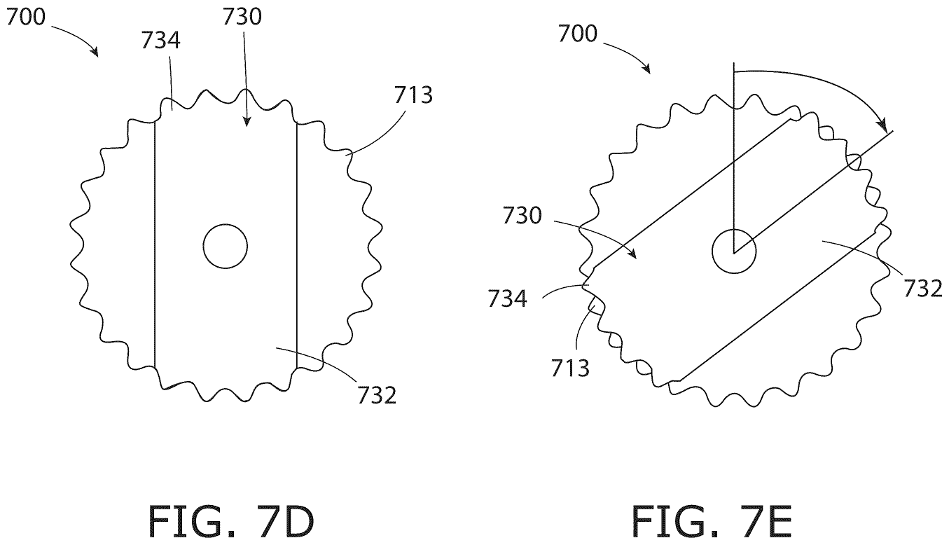

FIGS. 7A-7E depict perspective views, cross-sectional views, and front views of a constant velocity joint 700 and retention mechanism 730, according to one or more embodiments of the disclosure. Specifically, FIG. 7A depicts a forward perspective view of a constant velocity joint 700, FIGS. 7B-7C depict cross-sectional views of the constant velocity joint 700 and receiver 714, and FIGS. 7D-7E depict forward views of the retention mechanism 730, according to one or more embodiments. In one or more embodiments, the housing 702 is similar to housing 402 depicted above in FIGS. 4A-4D. For example, in various embodiments housing 702 extends from a rearward end 704 to a forward end 706. In one or more embodiments the housing 702 defines an aperture 708 in the rearward end 704 into an interior space 710 that is surrounded by the exterior cylindrical body 703 for receiving and rotatably connecting with an axle. A forward locking element 712 is positioned on the forward end 706 of the housing 702. The forward locking element 712 is configured as a locking mechanism for installation into a receiving hub 714 of a wheel hub and/or drive unit, such as a front drive, rear drive, differential, or transmission. In one or more embodiments, the forward locking element includes a plurality of splines 713 that extend parallel with a central axis 716 of the housing 702 and are distributed circumferentially about the forward locking element 712.

In various embodiments, the forward locking element 712 further includes the retention mechanism 730. In various embodiments the retention mechanism 730 includes a spline lock 732 that is rotationally mounted to a forward face of the locking element 712. In various embodiments the spline lock 732 comprises a toolless locking half shaft retention system using a rotating, interrupted spline positioned adjacent to splines 713 of the forward locking element 712. In such embodiments the retention mechanism 730 defines a separate section of spline 734 that is connected to the main section by a rotating shaft 736. The retention mechanism 730 and splined section 734 can be rotated by various methods, such as a lever or cammed feature. In certain embodiments, a rotational spring 738 is mounted to the shaft 736 and is configured to rotate the mechanism 730 from a first position, such as depicted in FIG. 7D, to a second position, such as depicted in FIG. 7E, where the splined section 734 and the splines 713 are misaligned and prevent the typical sliding interaction between the splined receiver and splined CV joint 700. As shown in FIGS. 7B-7C, during installation, the operator aligns the splined section 734 with the main splines 713, allowing the locking mechanism 712 to slide into the receiver 714. When fully seated, the rotating splines 734 enter a groove 740 and the spring 738 rotates the mechanism 730 such that the splines are subsequently misaligned, locking the housing in place. To remove, the operator rotates the splined section 734 back into alignment, enabling removal from the receiver 714.

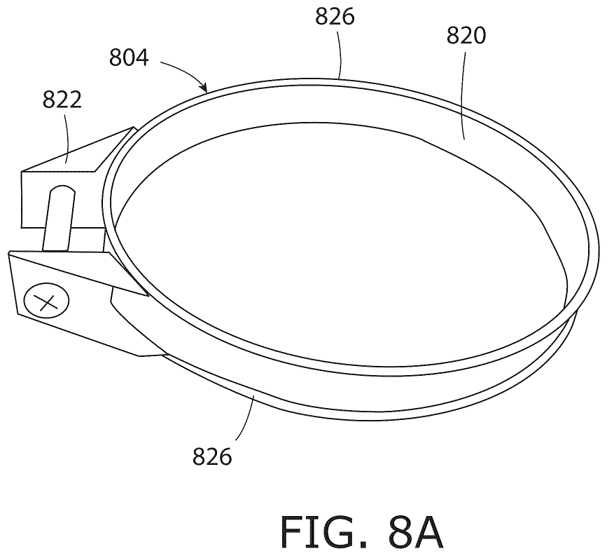

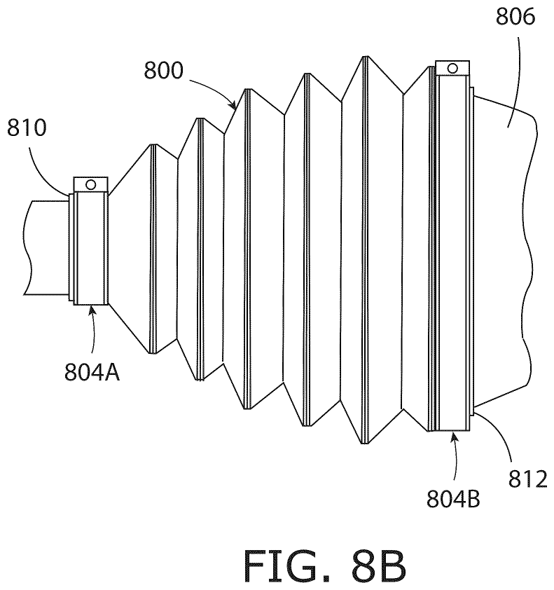

FIGS. 8A-8B depict a constant velocity boot 800 and a boot clamp 804, according to one or more embodiments of the disclosure. In one or more embodiments a constant velocity joint 806 is enclosed within the flexible boot 800. In various embodiments, such boots 800 include a first end 810 and a second end 812. In one or more embodiments the first end 810 is generally a smaller end and retained by a first clamp 804A on the half axle leading out of the joint. In one or more embodiments the second end 812 is a relatively larger end that is clamped, via a second clamp 804B, to an annular surface of the body of the CV joint 806. In one or more embodiments, the boot 800 and the first and second clamps 804A, 804B assist to provide a seal for the joint 806 over the operating range of the constant velocity joint. In one or more embodiments the boot 800 is molded of elastomeric material, such as rubber, for example, which permits the boot to flex with the flexing of the joint.

In one or more embodiments the clamps 804 include a ring 820 of metallic, polymer, fabric, or other suitable material having a selectively adjustable diameter controlled by a clamp mechanism 822. In various embodiments the ring 820 further includes a pair of raised edges 826. In such embodiments each of the raised edges 826 include a portion of material of the ring 820 that extends radially outwardly relative to a central axis through the ring 820. In such embodiments, the raised edges 826 cause less stress at edge of clamp, due to the curved edges created by the radially outwardly extending raised edges 826. Further, in various embodiments the raised edges 826 structurally reinforce the ring 820 and add stiffness radially to the part. Further, one or more embodiments reduce the risk of boot failure and/or leaking of grease.

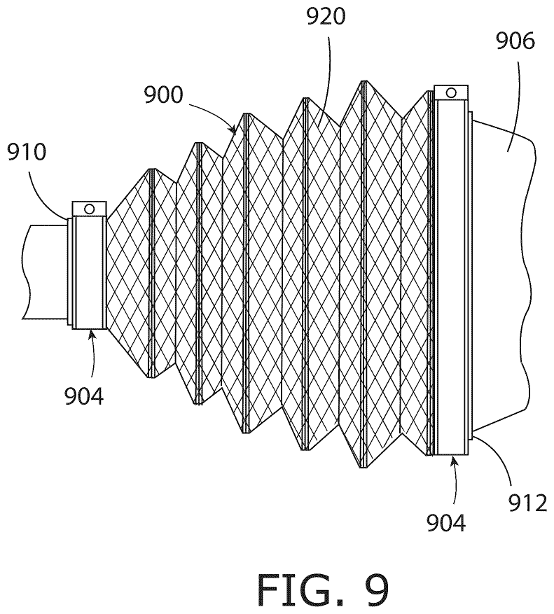

FIG. 9 depicts a side view of a constant velocity joint boot 900, according to one or more embodiments of the disclosure. In one or more embodiments boot 900 is similar to boot 800 described above in FIGS. 8A-8B. For example, in various embodiments the boot 900 includes a first end 910 and a second end 812 clamped via a clamp 904 against a constant velocity joint 906 and an axle. In one or more embodiments the boot 900 includes a metallic mesh layer 920. In one or more embodiments, the mesh layer 920 is composed of wire mesh, or other material with highly ductile steel material. In one or more embodiments the mesh layer 920 is surrounded around the boot 900. In such embodiments the mesh layer 920 functions to protect the boot from foreign objects, such as rocks, branches, and the like.

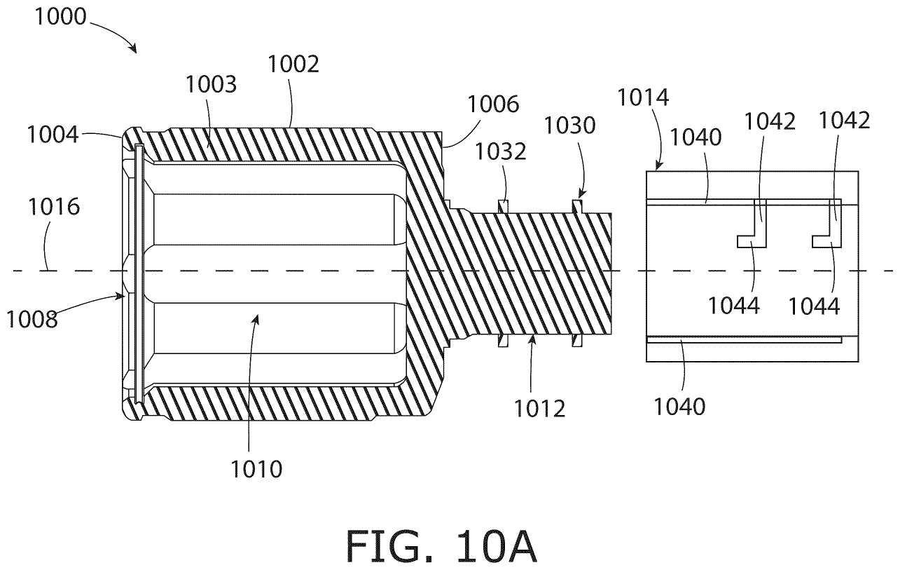

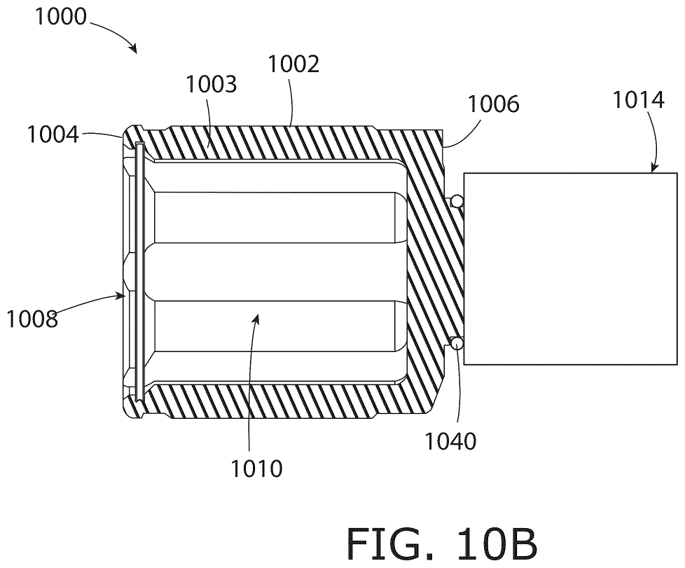

FIGS. 10A-10B depicts cross-sectional side views of a constant velocity joint housing 1002 and a retention mechanism 1030, according to one or more embodiments of the disclosure. In one or more embodiments, the housing 1002 is similar to housing 402 depicted above in FIGS. 4A-4D. For example, in various embodiments housing 1002 extends from a rearward end 1004 to a forward end 1006. In one or more embodiments the housing 1002 defines an aperture 1008 in the rearward end 1004 into an interior space 1010 that is surrounded by the exterior cylindrical body 1003 for receiving and rotatably connecting with an axle. A forward locking element 1012 is positioned on the forward end 1006 of the housing 1002. The forward locking element 1012 is configured as a locking mechanism for installation into a receiving hub 1014 of a wheel hub and/or drive unit, such as a front drive, rear drive, differential, or transmission.

In one or more embodiments, the forward locking element 1012 includes the retention mechanism 1030. In various embodiments the retention mechanism 1030 addresses half shaft retention problems in vehicles caused by various factors, including high horsepower engines, vibrations, ground clearance, and assembly tolerances. In various embodiments the retention mechanism 1030 involves removing splines from both the shaft and the gear interface, such as the splines discussed and described above with reference to FIGS. 4A-4D and replacing them with a specific number of drive pads or pins 1032. In various embodiments the receiver 1014 would further include a plurality of corresponding tracks 1036 or grooves in the shaft interfacing gear. In one or more embodiments the tracks 1036 include a first axial portion 1040 extending axially and providing a track for the pins 1032 to enter the receiver 1014, a first circumferential portion 1042 providing track for the pins 1032 to rotate and offset from the first axial portion 1040 and a second axial portion 1044 providing a track for the pins 1032 to move axially rearwardly into a groove and thereby provide a secure connection between the receiver 1014 and the housing 1002. In one or more embodiments, and depicted in FIG. 10B, once inserted into the corresponding tracks, a circlip 1040 can be inserted between the receiver 1014 and housing 1002 used to prevent axial movement and keep the shaft in place. In one or more embodiments, pins 1032 include a plurality of pins 1032 that are circumferentially spaced about the forward locking element. For example, in various embodiments, the pins 1032 could include a set of 3-6-9 or 12 pins or drive pads that are evenly spaced about the locking element. In certain embodiments the number and spacing of the pins can vary, for example, based on the number needed as required per vehicle. In certain embodiments the pins 1032 could be coinfigued as torque limiters by being configured to shear at a specific torque. In such embodiments the pins could be replacable components that could be replaced in the field to save the shaft from failure and/or other drive train components. In contrast with various embodiments, existing retention methods, such as bolted flanges, can be expensive and challenging to service in the field. For example, requiring machining and bolts that need to be tightened and set to specific torques.

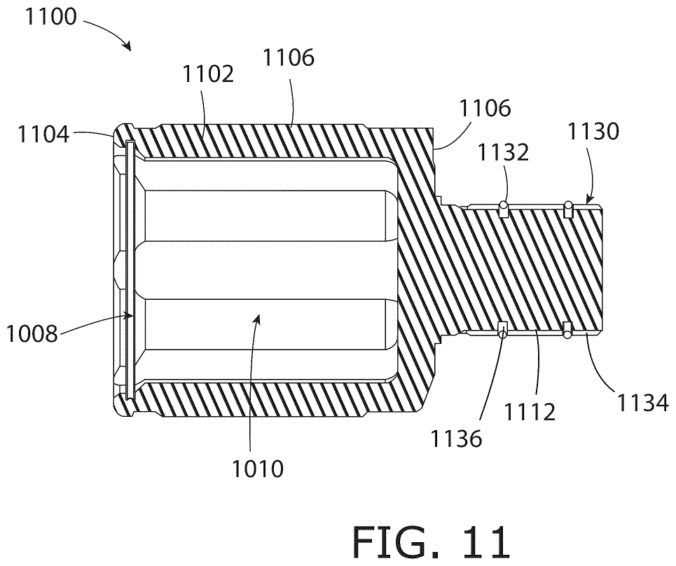

FIG. 11 depicts a cross-sectional side view of a constant velocity joint housing 1102 and a retention mechanism 1130, according to one or more embodiments of the disclosure. In one or more embodiments, the housing 1102 is similar to housing 402 depicted above in FIGS. 4A-4D. For example, in various embodiments housing 1102 extends from a rearward end 1104 to a forward end 1106. In one or more embodiments the housing 1102 defines an aperture 1108 in the rearward end 1104 into an interior space 1110 that is surrounded by the exterior cylindrical body for receiving and rotatably connecting with an axle. A forward locking element 1112 is positioned on the forward end 1106 of the housing 1102. The forward locking element 1112 is configured as a locking mechanism for installation into a receiving hub of a wheel hub and/or drive unit, such as a front drive, rear drive, differential, or transmission.

In one or more embodiments, the forward locking element 1012 includes the retention mechanism 1130. In various embodiments the retention mechanism 1130 includes a plurality of splines 1134 and a plurality of grooves 1136 and retention rings 1132 around the diameter of the splines 1134. In such embodiments, the use of multiple flexible retaining rings provide for improved shaft retention in spline joints. For example, in various embodiments the rings 1132 are placed axially along the spline, with respective grooves in the mating spline allowing for expansion and axially securing the housing 1102 in place in the receiver. In one or more embodiments the placement of the rings 1132 and grooves 1136 can be calibrated for the desired retention force, and opposing rings can preload the system to remove slack or play in the joint. In such embodiments, the multiple retention ring design solves various problems associated with single-ring designs. One or more embodiments assist in preventing shafts from unexpectedly pulling apart by either increasing the force required to pull the shaft outward or acting as a backup system. For example, if the shaft begins to separate, internal retention rings can engage in another groove, preventing complete joint separation and allowing operators to correct the issue before damage occurs. Additionally, this design provides more consistent retention and reduces slop. Single-ring designs may have axial movement due to manufacturing tolerances, increasing the likelihood of joint disengagement. With multiple rings, the joint can be designed to eliminate this movement and prevent joint failure. While FIG. 11 depicts a design with multiple rings, in some embodiments, rather than multiple rings, certain embodiments could include placing one ring near the middle of the spline length to increase location accuracy and reduce play.

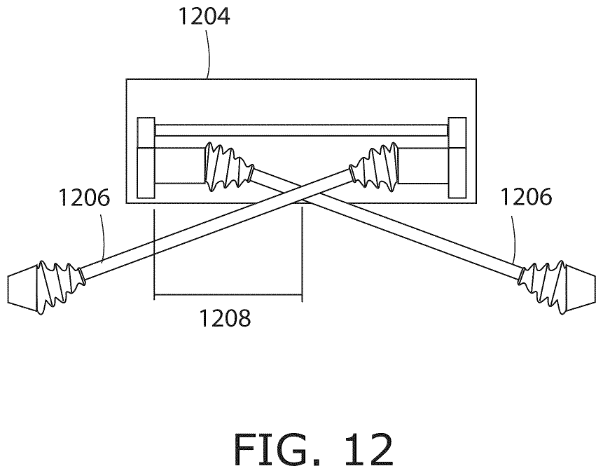

FIG. 12 depicts a rear view of a differential 1204 equipped with a pair of cross-over half shafts 1206, as described in one or more embodiments of the disclosure. In various embodiments, the suspension travel of the drivetrain component may be restricted by numerous factors, one of which is the half shaft angle. For instance, the suspension travel can be constrained by the angular range of the constant velocity joints, the length of the half shafts, and other related factors. As the size of the half shafts grows, the angle between the differential and the wheel hub also increases, which may consequently limit suspension travel.

Additionally, width constraints on recreational vehicles pose challenges for developing ultra-long travel suspensions. One particularly challenging component to accommodate and optimize is the half shaft. In various embodiments designed to complement the long travel suspension, half shafts can be arranged in a “crossed” configuration, where each half shaft extends across the differential body, resulting in a crossover of half axles. In such designs, the length of the half shafts can be increased by at least the extent of the crossover 1208.

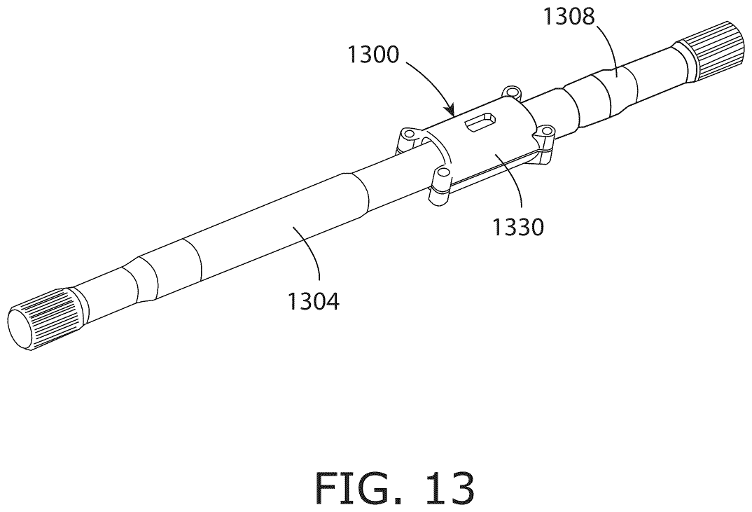

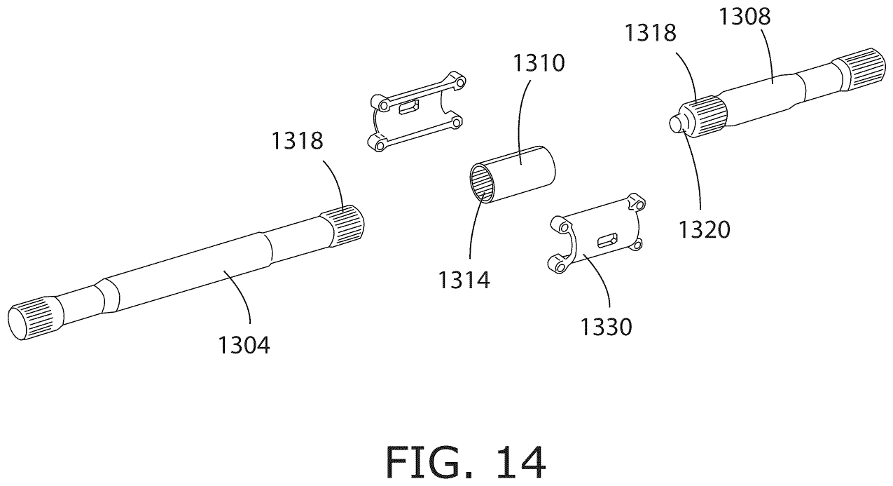

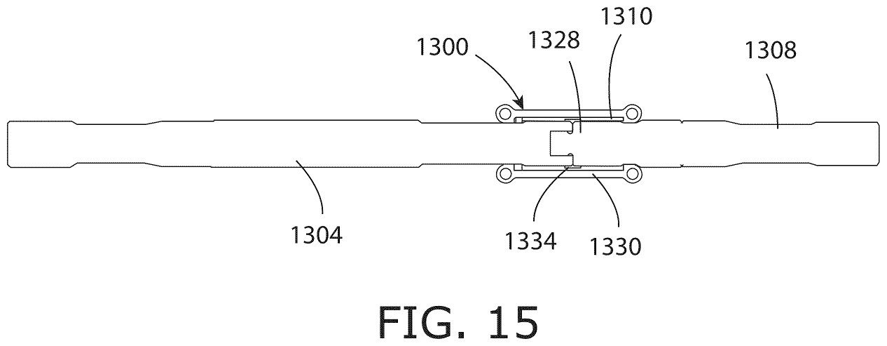

FIGS. 13-16 various views of a coupling device 1300, according to one or more embodiments of the disclosure. Specifically, various embodiments provide a coupling device 1300 for connecting two rotating shafts 1304, 1308, such as half shafts, drive shafts, and the like, together. In one embodiment, the coupling device 1300 comprises at least two portions or halves that when put together define a circular sleeve 1310 for connecting the rotating shafts 1304, 1308. The interior of the sleeve includes a plurality of splines 1314 along its length for rotationally coupling to the splined portions 1318 of the two rotating shafts 1304, 1308. As such, in various embodiments the coupling device 1300 is responsible for passing torque between the connected shafts. Broken half shafts, drive shafts, and the like often occur in the harshest riding conditions, sometimes leaving the vehicle stranded. Replacement of the shaft is complicated and cumbersome for some customers and impossible to perform trailside with basic tools. As such, various embodiments provide an innovative advantage by offering a simple solution that requires a minimal number of tools and can easily be performed trail side. Unlike most rotating or power transmitting shafts that use a pin or fuse point designed into one of the dedicated system parts, this design uses a dedicated sleeve to accomplish the same task. The design allows the owner/operator to carry a small, simple part that can be replaced without the need for special tools trail side. Furthermore, the design also restores the torque carrying capacity back to production values, as opposed to a reduced level to simply “limp” the vehicle home. The coupling device 1300 preserves the strength of the previous designs, providing a reliable and effective solution for connecting rotating shafts in various applications including powersports and automotive applications pertaining to any sort of rotating shaft.

In one or more embodiments, a fully assembled pair of rotating shafts would include a first drivetrain shaft 1304 and a second drivetrain shaft 1308. The second drivetrain shaft 1308 includes a shaft pilot 1320 configured to couple with a corresponding pilot aperture 1322 in the first drivetrain shaft 1304 to couple the first and second drivetrain shafts together and resist axial movement that would separate the drivetrain shafts. In various embodiments the ends of the drivetrain shafts each include a splined portion 1318 or axle spline for rotationally coupling to another element. In such embodiments, when the first and second drivetrain shafts 1304, 1308 are coupled together, the splined portions 1318 are aligned to define a combined spline portion 1328.

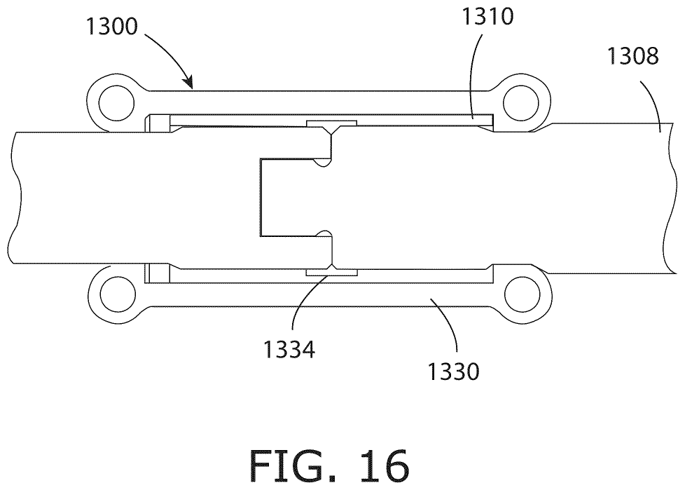

In various embodiments the sleeve 1310 is assembled over the combined spline portion 1328, and the splines 1314 of the sleeve interlock with the splines 1318 of the rotating shafts to form one connected rotating shaft. In various embodiments, the sleeve 1310 can further include connectors for securing the halves or portions of the sleeve together on the combined spline portion 1328. Depicted in FIGS. 13-16, in some embodiments, the coupling device 1300 further includes a clamping assembly 1330 comprising two or more parts that are assembled and tightened together over the sleeve 1310 with screws 1332 extending into threaded apertures of the clamp portions to lock the portions of the sleeve 1310 in place. Depicted in FIG. 16 in one or more embodiments, the coupling device 1300 contains a shearing feature 1334 responsible for shearing in the event of an overload condition to protect the rest of the driveline. In one or more embodiments the shearing feature 1334 is a relatively thinner portion of the sleeve 1310 that is designed to shear before the rotating shafts. Depicted in FIG. 16, The designed shear location is in the collar where the rotating shafts 1304, 1308 are joined.

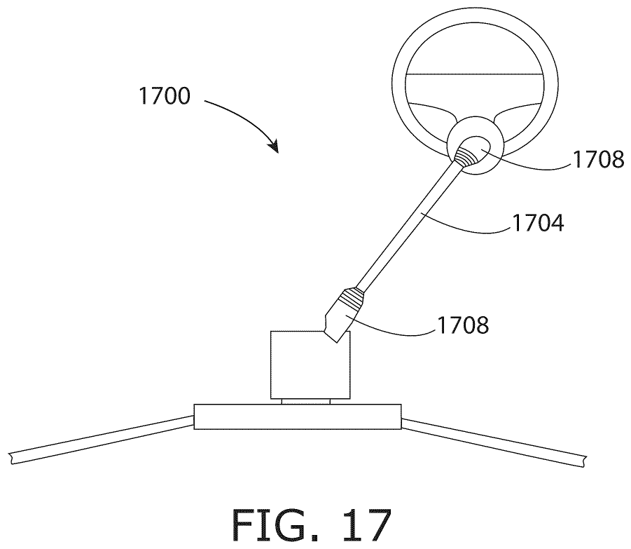

Referring to FIG. 17 a steering system architecture 1700 with a constant velocity joint steering shaft 1704 is depicted, according to one or more embodiments of the disclosure. Specifically, embodiments of the present invention provide a steering system architecture 1700 with a constant velocity joint steering shaft 1704 that incorporates dual constant velocity joints 1708 for improved performance and a more compact design. In one or more embodiments the steering system architecture 1700 achieves a smaller size and a larger operating angle as compared to existing systems. In contrast, existing steering systems and almost all other automotive applications utilize universal joint steering shafts. In some cases, heavy-duty applications may use constant velocity joint steering shafts in steering systems, but these are typically a combination of CVJ and UJ shafts.

In various embodiments the steering system architecture 1700 addresses the limitations of non-constant velocity joints by using two joints 1708 with special geometrical construction to obtain constant velocity performance. To improve this situation, a new constant velocity steering joint (CSJ) has been developed. The CSJ features an outer and inner ball race, and their tracks are reversed in this design, which differentiates it from existing joint designs. Moreover, the inclusion of a spring-controlled spherical plate is a unique design element that helps reduce backlash in the system. In various embodiments this innovative CSJ design allows for the transmission of constant velocity with a higher operating angle, resulting in smoother operation. The CSJ offers several advantages over double Cardan joint arrangements, including lighter weight and a more compact design. These characteristics provide significantly greater freedom for steering system design layout, enabling more efficient and flexible configurations. In such embodiments, the steering system architecture, in its compact size, allows it to transmit constant velocity effectively. Further, various embodiments achieve a higher operating angle of up to 50 degrees maximum. These features, in combination with the unique design elements of the CSJ, enable improved performance and greater versatility in steering system design across various automotive applications.

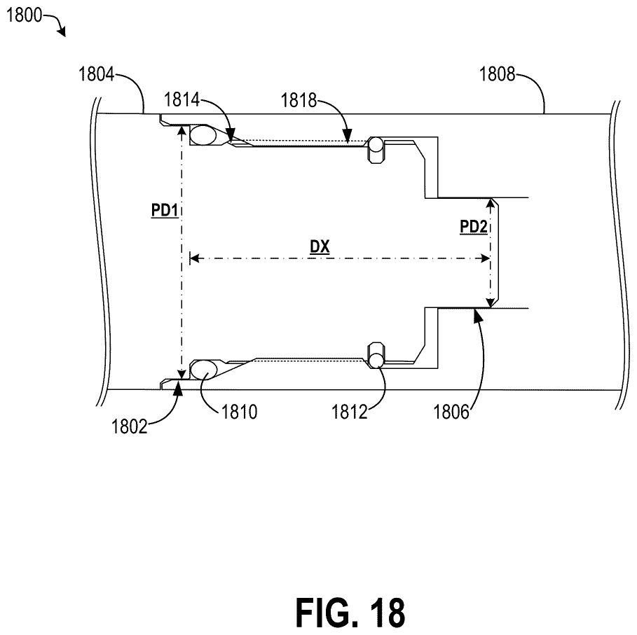

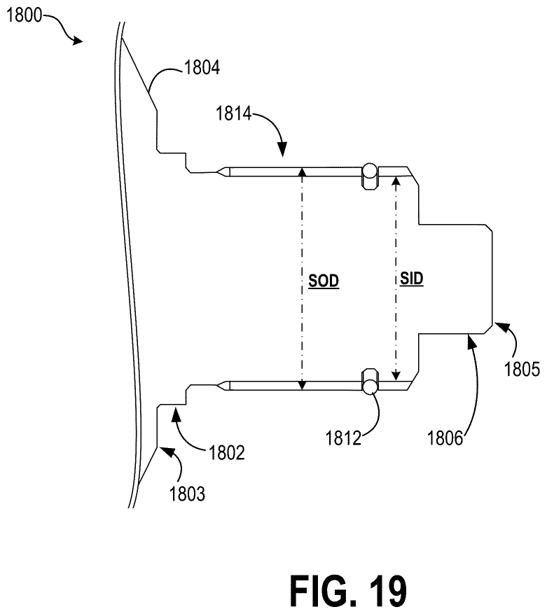

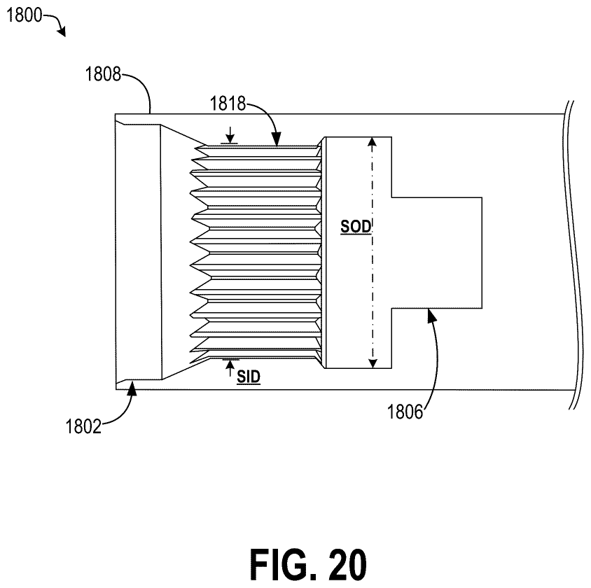

FIGS. 18-20 are various views of a double-piloted spline interface 1800, according to one or more embodiments of the disclosure. FIG. 18 illustrates an example cross-sectional view of double-pilot spline joint 1800. Various embodiments provide a double-piloted spline interface 1800 for connecting two rotating shafts 1804, 1808, such as half shafts, drive shafts, and the like, together. Double-piloted spline interface 1800 is defined by a male spline portion 1814 of shaft 1804 and a female spline portion 1818 of shaft 1808. FIGS. 19 and 20 illustrate example cross-sectional views of male spline portion 1814 and female spline portion 1816, respectively. In various embodiments the double-piloted spline interface 1800 is responsible for passing torque between the connected shafts. When operated on trails or other offroad environments, debris may intrude into spline connections causing wear. Additionally, or alternatively, aggressive operation may cause premature wearing of splines. To reduce or prevent debris intrusion or premature wear, an innovative advantage of double-piloted spline interface 1800 includes a first pilot 1802 and a second pilot 1806. For example, double-piloted spline interface 1800 may reduce spline wear and improve axial alignment of half shaft interfaces by utilizing an outer and inner pilot diameter to increase moment arm distance and allow for tighter diametral clearances and tolerances. Moreover, the double-pilot may prevent debris intrusion by reducing diametral clearance within the interface. In some examples, double-piloted spline interface 1800 may include optional first O-ring 1810 and second O-ring 1812, which may further aid in reducing debris intrusion and/or enhance alignment of male spline portion 1814 relative to female spline portion 1816.

First pilot 1802 and second pilot 1806 may have features that provide improved performance. For example, a diameter PD1 of first pilot 1802, which is located toward the outboard end 1830, is larger than the spline outer diameter SOD. Additionally, a diameter of second pilot 1806 PD2, which is located toward inboard end 1805, is smaller than the spline internal diameter SID. In some examples, inboard end 1805 may define an internal feature, e.g., a dimple or a depression, to permit a turning center geometry (e.g., lathe) to assist in manufacturing.

Generally, first pilot 1802 and second pilot 1806 define the points about which shafts 1804 and 1808 rotate. Tolerances on PD1 and PD2 define a magnitude of rotation. Distance DX defines the moment arm distance of double-pilot spline interface 1800. DX is larger than a single pilot joint, as the second location is dependent upon spline fitment. A longer DX and tighter tolerances at PD1 and PD2 may provide reduce rocking of double-pilot spline interface 1800, thereby reducing premature wear and limiting debris intrusion. Moreover, reduced magnitude of rotation results in a sealing interface, which may utilize optional O-rings 1810 and 1812 to seal with reduced variation in O-ring compression and reduced side-loading of double-pilot spline interface 1800.

The following clauses illustrate examples subject matter described herein.

Clause 1. A constant velocity joint for a recreational vehicle, the constant velocity joint comprising: a housing extending from a rearward end to a forward end, the housing being a generally cylindrical body formed from a rigid material; an aperture defined in the rearward end of the housing for receiving and rotatably connecting with an axle, the aperture leading to an interior space surrounded by the cylindrical body; one or more interior components for rotatably connecting the axle to the housing; and a forward locking element positioned on the forward end of the housing, the forward locking element comprising a plurality of splines that extend parallel with a central axis of the housing and are distributed circumferentially about the forward locking element, a circumferential groove in the forward locking element, a snap ring inserted into the groove, and a hydraulic locking mechanism for locking the housing in place upon installation into a receiver, the hydraulic locking mechanism comprising: a hydraulic channel with hydraulic fluid, a set screw, and a movable set pin, the hydraulic channel having at least two ends, including a first end and a second end, the first end defining a first opening into the hydraulic channel and the second end positioned adjacent to the groove of the forward locking element, the movable set pin positioned in the second end of the channel and being vertically adjustable, via fluid pressure in the channel, such that the set pin determines the depth of the groove via its relative position in the second end, and the set screw positioned in the first end of the channel and being vertically adjustable upwardly or downwardly to increase or decrease the pressure from hydraulic fluid in the channel.

Clause 2. The constant velocity joint of clause 1, wherein the hydraulic locking mechanism facilitates insertion and retention of the joint once installed in the receiver, the mechanism operating by increasing hydraulic pressure in the channel upon installation of the housing into the receiver to force the movable set pin to extend into a corresponding feature in the receiving hub and effectively retain the constant velocity joint from inside the receiver.

Clause 3. The constant velocity joint of clause 1, wherein the hydraulic locking mechanism facilitates removal of the joint by decreasing hydraulic pressure in the channel to cause the set pin to withdraw the snap ring, allowing for removal of the constant velocity joint.

Clause 4. The constant velocity joint of clause 1, wherein the hydraulic channel includes additional ends and additional set pins arranged in the forward locking element.

Clause 5. The constant velocity joint of clause 1, wherein the snap ring is part of a protrusion of the set pin that when extended radially out from the groove, functions to lock with the receiver.

Clause 6.The constant velocity joint of clause 1, wherein the receiver includes a plurality of corresponding splines and a groove for receiving the snap ring.

Clause 7. The constant velocity joint of clause 6, wherein the splines interlock to resist rotational force between the receiver and housing while the snap ring and groove function to resist rearward movement of the locking element that would separate the connected housing and receiver.

Clause 8. The constant velocity joint of clause 6, wherein the housing and the receiver define a double-pilot spline interface.

Clause 9. The constant velocity joint of clause 1, wherein the housing and forward locking element are formed from multiple pieces coupled together to form the constant velocity joint.

Clause 10. A constant velocity joint for a recreational vehicle, the constant velocity joint comprising: a housing extending from a rearward end to a forward end, the housing being a generally cylindrical body formed from a rigid material; an aperture defined in the rearward end of the housing for receiving and rotatably connecting with an axle, the aperture leading to an interior space surrounded by the cylindrical body; one or more interior components for rotatably connecting the axle to the housing; and a forward locking element positioned on the forward end of the housing, the forward locking element comprising a plurality of splines that extend parallel with a central axis of the housing and are distributed circumferentially about the forward locking element, a circumferential groove in the forward locking element, a snap ring inserted into the groove, and a retention mechanism, the retention mechanism comprising a conical disc having a diameter that approximately matches the diameter of a forward face of the forward locking element, the conical disc defining a concave surface and a convex surface; wherein, when inserted into a receiver, side edges of the conical disc engage the interior surface of the receiver when the housing is pulled rearwardly such that the conical disc provides additional frictional force to resist rearward pull-out force.

Clause 11. The constant velocity joint of clause 10, wherein the conical disc is configurable between at least two configurations, including a first configuration where the concave surface is rearwardly facing and the convex surface is forward facing for insertion of the forward locking element and disc retention mechanism into the receiver with reduced friction between the conical disc and the sides of the receiver, and a second configuration where the concave surface is forward facing and the convex surface is rearward facing to provide additional retention force in the axial direction to overcome pull-out forces.

Clause 12. The constant velocity joint of clause 10, wherein the conical disc provides an additional pull-out resistance of approximately 956 N.

Clause 13. The constant velocity joint of clause 12, wherein combined with the snap ring, the constant velocity joint provides a total pull-out resistance of approximately 1721 N.

Clause 14. A constant velocity joint for a recreational vehicle, the constant velocity joint comprising: a housing extending from a rearward end to a forward end, the housing being a generally cylindrical body formed from a rigid material; an aperture defined in the rearward end of the housing for receiving and rotatably connecting with an axle, the aperture leading to an interior space surrounded by the cylindrical body; one or more interior components for rotatably connecting the axle to the housing; a forward locking element positioned on the forward end of the housing, the forward locking element comprising a plurality of splines that extend parallel with a central axis of the housing and are distributed circumferentially about the forward locking element, a circumferential groove in the forward locking element, and a snap ring inserted into the groove; and an axial spring extending between a forward-facing end surface of the axle and a rearward interior surface of the housing, the axial spring including a cup connected to one or both ends of the spring, the cup being shaped to conform with one or more of the axle and the rearward interior surface; wherein the axial spring maintains a minimum axial spacing between the outer element and the inner element for resisting pull-out forces on the constant velocity joint by assisting the housing to maintain its forward position inside the receiver.

Clause 15. A constant velocity joint for a recreational vehicle, the constant velocity joint comprising: a housing extending from a rearward end to a forward end, the housing being a generally cylindrical body formed from a rigid material; an aperture defined in the rearward end of the housing for receiving and rotatably connecting with an axle, the aperture leading to an interior space surrounded by the cylindrical body; one or more interior components for rotatably connecting the axle to the housing; and a forward locking element positioned on the forward end of the housing, the forward locking element comprising a plurality of splines that extend parallel with a central axis of the housing and are distributed circumferentially about the forward locking element, a circumferential groove in the forward locking element, a snap ring inserted into the groove, and a retention mechanism, the retention mechanism comprising a spline lock that is rotationally mounted to a forward face of the locking element via a rotating shaft, the spline lock being a toolless locking half shaft retention system defining a separate a rotating set of splines positioned adjacent to splines of the forward locking element; a rotational spring mounted to the shaft and configured to rotate the mechanism from a first position where the splined section and the splines are aligned, to a second position where the splined section and the splines are misaligned, preventing a sliding interaction between a splined receiver and splined constant velocity joint.

Clause 16. The constant velocity joint of clause 15, wherein during installation, the rotating set of splines are aligned with splines of the forward locking element to allow the locking mechanism.

Clause 17. The constant velocity joint of clause 16, wherein when fully seated, the rotating splines enter a groove in the receiver and the spring rotates the mechanism such that the splines are subsequently misaligned, locking the housing in place.

Clause 18. A constant velocity joint for a recreational vehicle, the constant velocity joint comprising: a housing extending from a rearward end to a forward end, the housing being a generally cylindrical body formed from a rigid material; an aperture defined in the rearward end of the housing for receiving and rotatably connecting with an axle, the aperture leading to an interior space surrounded by the cylindrical body; one or more interior components for rotatably connecting the axle to the housing; and a forward locking element positioned on the forward end of the housing, the forward locking element comprising a retention mechanism comprising one or more or pins positioned on the forward locking element and corresponding with one or more tracks in a receiver; wherein the one or more tracks in the receiver comprise a first axial portion extending axially for providing a track for the pins to enter the receiver, a first circumferential portion providing a track for the pins to rotate and offset from the first axial portion, and a second axial portion providing a track for the pins to move axially rearwardly into a groove, thereby providing a secure connection between the receiver and the housing.

Clause 19. The constant velocity joint of clause 18, further comprising a circular clip inserted between the receiver and housing to prevent axial movement and keep the shaft in place.

Clause 20. The constant velocity joint of clause 18, wherein the one or more pins comprise a plurality of pins circumferentially spaced about the forward locking element.

Clause 21. The constant velocity joint of clause 18, wherein the one or more pins are configured as torque limiters by being configured to shear at a predetermined torque.

Clause 22. The constant velocity joint of clause 18, wherein the forward locking element does not include splines.

Clause 23. A constant velocity joint for a recreational vehicle, the constant velocity joint comprising: a housing extending from a rearward end to a forward end, the housing being a generally cylindrical body formed from a rigid material; an aperture defined in the rearward end of the housing for receiving and rotatably connecting with an axle, the aperture leading to an interior space surrounded by the cylindrical body; one or more interior components for rotatably connecting the axle to the housing; and a forward locking element positioned on the forward end of the housing, the forward locking element comprising a plurality of splines that extend parallel with a central axis of the housing and are distributed circumferentially about the forward locking element, and a plurality of circumferential grooves spaced axially along the forward locking element, the plurality of circumferential grooves each including a snap ring inserted into the groove.

Clause 24. A coupling device for connecting a first drivetrain shaft and a second drivetrain shaft, the first and second drivetrain shafts each having a splined portion, wherein when the first and second drivetrain shafts are positioned end to end, the splined portions of the first and second drivetrain shafts define a combined spline portion, the coupling device comprising: a sleeve including at least two portions, each portion having an interior surface with a plurality of splines configured to engage with the combined splined portions of the first and second drivetrain shafts, wherein the at least two portions, when assembled, define the sleeve; and a clamping assembly including two or more parts for securing the at least two portions of the sleeve over the combined spline portion.

Clause 25. The coupling device of clause 24, further comprising a shear feature in the sleeve designed to shear upon experiencing an overload condition to protect the driveline, wherein the shear feature is a portion of thin sidewall, relative to a remainder of sidewall, located in the sleeve where the first and second drivetrain shafts are joined.

Clause 26. The coupling device of clause 24, wherein the first drivetrain shaft includes a shaft pilot configured to couple with a corresponding pilot aperture in the second drivetrain shaft to resist axial movement separating the first and second drivetrain shafts.

Clause 27. The coupling device of clause 24, wherein the clamping assembly is included in the sleeve including connectors for securing the at least two portions of the sleeve together on the combined spline portion.

Clause 28. The coupling device of clause 24, wherein the clamping comprises two or more parts that are assembled and tightened together over the sleeve to lock the portions of the sleeve in place.

Clause 29. The coupling device of clause 24, wherein the shear feature is designed to shear before the rotating shafts.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A constant velocity joint for a recreational vehicle, the constant velocity joint comprising:
a housing extending from a rearward end to a forward end, the housing being a generally cylindrical body formed from a rigid material;
an aperture defined in the rearward end of the housing for receiving and rotatably connecting with an axle, the aperture leading to an interior space surrounded by the cylindrical body;
one or more interior components for rotatably connecting the axle to the housing; and
a forward locking element positioned on the forward end of the housing, the forward locking element comprising a plurality of splines that extend parallel with a central axis of the housing and are distributed circumferentially about the forward locking element, a circumferential groove in the forward locking element, and a snap ring inserted into the groove.

2. The constant velocity joint of claim 1, wherein the forward locking element further comprises a hydraulic locking mechanism for locking the housing in place upon installation into a receiver, the hydraulic locking mechanism comprising: a hydraulic channel with hydraulic fluid, a set screw, and a movable set pin, the hydraulic channel having at least two ends, including a first end and a second end, the first end defining a first opening into the hydraulic channel and the second end positioned adjacent to the groove of the forward locking element, the movable set pin positioned in the second end of the channel and being vertically adjustable, via fluid pressure in the channel, such that the set pin determines the depth of the groove via its relative position in the second end, and the set screw positioned in the first end of the channel and being vertically adjustable upwardly or downwardly to increase or decrease the pressure from hydraulic fluid in the channel.

3. The constant velocity joint of claim 2, wherein the hydraulic locking mechanism facilitates insertion and retention of the joint once installed in the receiver, the mechanism operating by increasing hydraulic pressure in the channel upon installation of the housing into the receiver to force the movable set pin to extend into a corresponding feature in the receiving hub and effectively retain the constant velocity joint from inside the receiver.

4. The constant velocity joint of claim 2, wherein the hydraulic locking mechanism facilitates removal of the joint by decreasing hydraulic pressure in the channel to cause the set pin to withdraw the snap ring, allowing for removal of the constant velocity joint.

5. The constant velocity joint of claim 2, wherein the hydraulic channel includes additional ends and additional set pins arranged in the forward locking element.

6. The constant velocity joint of claim 2, wherein the snap ring is part of a protrusion of the set pin that when extended radially out from the groove, functions to lock with the receiver.

7. The constant velocity joint of claim 2, wherein the receiver includes a plurality of corresponding splines and a groove for receiving the snap ring.

8. The constant velocity joint of claim 7, wherein the splines interlock to resist rotational force between the receiver and housing while the snap ring and groove function to resist rearward movement of the locking element that would separate the connected housing and receiver.

9. The constant velocity joint of claim 6, wherein the housing and the receiver define a double-pilot spline interface.

10. The constant velocity joint of claim 2, wherein the housing and forward locking element are formed from multiple pieces coupled together to form the constant velocity joint.

11. The constant velocity joint of claim 1, wherein the forward locking element further comprises
a retention mechanism, the retention mechanism comprising a conical disc having a diameter that approximately matches the diameter of a forward face of the forward locking element, the conical disc defining a concave surface and a convex surface;
wherein, when inserted into a receiver, side edges of the conical disc engage the interior surface of the receiver when the housing is pulled rearwardly such that the conical disc provides additional frictional force to resist rearward pull-out force.

12. The constant velocity joint of claim 11, wherein the conical disc is configurable between at least two configurations, including a first configuration where the concave surface is rearwardly facing and the convex surface is forward facing for insertion of the forward locking element and disc retention mechanism into the receiver with reduced friction between the conical disc and the sides of the receiver, and a second configuration where the concave surface is forward facing and the convex surface is rearward facing to provide additional retention force in the axial direction to overcome pull-out forces.

13. The constant velocity joint of claim 11, wherein the conical disc provides an additional pull-out resistance of approximately 956 N, and wherein combined with the snap ring, the constant velocity joint provides a total pull-out resistance of approximately 1721 N.

14. A constant velocity joint for a recreational vehicle, the constant velocity joint comprising:
a housing extending from a rearward end to a forward end, the housing being a generally cylindrical body formed from a rigid material;
an aperture defined in the rearward end of the housing for receiving and rotatably connecting with an axle, the aperture leading to an interior space surrounded by the cylindrical body;
one or more interior components for rotatably connecting the axle to the housing; and
a forward locking element positioned on the forward end of the housing, the forward locking element comprising a plurality of splines that extend parallel with a central axis of the housing and are distributed circumferentially about the forward locking element, a circumferential groove in the forward locking element, a snap ring inserted into the groove, and a retention mechanism, the retention mechanism comprising a spline lock that is rotationally mounted to a forward face of the locking element via a rotating shaft, the spline lock being a toolless locking half shaft retention system defining a separate a rotating set of splines positioned adjacent to splines of the forward locking element;
a rotational spring mounted to the shaft and configured to rotate the mechanism from a first position where the splined section and the splines are aligned, to a second position where the splined section and the splines are misaligned, preventing a sliding interaction between a splined receiver and splined constant velocity joint.

15. The constant velocity joint of claim 14, wherein during installation, the rotating set of splines are aligned with splines of the forward locking element to allow the locking mechanism.

16. The constant velocity joint of claim 15, wherein when fully seated, the rotating splines enter a groove in the receiver and the spring rotates the mechanism such that the splines are subsequently misaligned, locking the housing in place.

17. A constant velocity joint for a recreational vehicle, the constant velocity joint comprising:
a housing extending from a rearward end to a forward end, the housing being a generally cylindrical body formed from a rigid material;
an aperture defined in the rearward end of the housing for receiving and rotatably connecting with an axle, the aperture leading to an interior space surrounded by the cylindrical body;
one or more interior components for rotatably connecting the axle to the housing; and
a forward locking element positioned on the forward end of the housing, the forward locking element comprising a retention mechanism comprising one or more or pins positioned on the forward locking element and corresponding with one or more tracks in a receiver;
wherein the one or more tracks in the receiver comprise a first axial portion extending axially for providing a track for the pins to enter the receiver, a first circumferential portion providing a track for the pins to rotate and offset from the first axial portion, and a second axial portion providing a track for the pins to move axially rearwardly into a groove, thereby providing a secure connection between the receiver and the housing.

18. The constant velocity joint of claim 17, further comprising a circular clip inserted between the receiver and housing to prevent axial movement and keep the shaft in place.

19. The constant velocity joint of claim 17, wherein the one or more pins comprise a plurality of pins circumferentially spaced about the forward locking element.

20. The constant velocity joint of claim 17, wherein the one or more pins are configured as torque limiters by being configured to shear at a predetermined torque.
